(19) United States
(12) Patent Application Publication
(10) Pub. No.: US 2012/0068434 A1
(43) Pub. Date: Mar. 22, 2012

(54) STEP BOARD

(76) Inventor: Seong Jin Park, Gyeonggi-do (KR)

(21) Appl. No.: 13/322,559

(22) PCT Filed: Jan. 27, 2010
(86) PCT No.: PCT/KR2010/000491

§ 371 Date: Nov. 26, 2011

(30) Foreign Application Priority Data
May 26, 2009 (KR) 10-2009-0046120

(51) Int. Cl. B62M 1/04

(52) U.S. Cl. 280/221

(57) ABSTRACT

The present invention relates to a step board, and has an object to provide a step board with simple parts in order to prevent minor malfunctions. In order to achieve the object above, the step board according to the present invention includes a plurality of bars, each having a top surface to step thereon and a bottom surface mounted with a rotation body, a driving section hinge-coupled with the front ends of the bars for rotatively supporting the bars in the vertical direction and mounted with a first caster on the bottom surface thereof, and a base plate rotatively coupled with the driving section at the front end thereof, mounted with a plurality of second casters on the bottom surface thereof and curved at a portion corresponding to the rotation body, wherein the rotation body rolls to move by rotating along the curved portion of the base plate as the plurality of bars rotate in the vertical direction.

### TECHNICAL FIELD

The present invention relates to a step board, and more particularly, a step board with simple parts in order to prevent minor malfunctions.

### BACKGROUND ART

A conventional step board is assembled with many parts, causing deterioration of productivity and frequent minor malfunctions due to damaged parts.

### DISCLOSURE

### Technical Problem

The present invention has been made to solve the problems and it is an object of the present invention to provide a step board which includes simple parts in order to prevent minor malfunctions and provides excellent durability.

It is another object of the present invention to provide a step board which reduces costs by using the minimum number of parts.

It is another object of the present invention to provide a step board which travels by freely changing a travel direction back and forth.

### Technical Solution

In order to achieve the object of the present invention, a step board comprises a plurality of bars, each having a top surface to step thereon and a bottom surface mounted with a rotation body, a driving section hinge-coupled with the front ends of the bars for rotatively supporting the bars in the vertical direction and mounted with a first caster on the bottom surface thereof, and a base plate rotatively coupled with the driving section at the front end thereof, mounted with a plurality of second casters on the bottom surface thereof and curved at a portion corresponding to the rotation body, wherein the rotation body rolls to move by rotating along the curved portion of the base plate as the plurality of bars rotate in the vertical direction.

The second casters comprise two casters and are provided in a triangular structure together with the first caster.

The first and second casters comprise directional casters which are inclined to one side at a mounting location.

The first and second casters rotate 360 degrees at the mounting location.

A footing is mounted in a top surface of the bars.

A rotation body comprises a roller, which is mounted to have an axial direction that is in parallel with a lengthwise direction of the bars.

The base plate is in a triangular structure, and a vertex in one side of the base plate is provided in a top surface of the driving section, wherein a rotating shaft passes through the base plate and the driving section, and the base plate rotates centering on the rotating shaft.

The remaining two vertexes of the base plate are curved upwardly.

### Advantageous Effect

As described above, a step board according to the present invention includes simple parts, prevents minor malfunctions and provides excellent durability.

Further, a step board according to the present invention uses the minimum number of parts used therein to thereby reduce costs and improve productivity.

### BRIEF DESCRIPTION OF DRAWINGS

FIG. 1 is a front view of a step board according to a first exemplary embodiment of the present invention.

FIG. 2 is a plan view of the step board in FIG. 1.

FIG. 3 is a left side view of the step board in FIG. 1.

FIG. 4 is a right side view of the step board in FIG. 1.

FIGS. 5 and 6 are right side views of an operational relationship of the step board according to the present invention.

FIGS. 7 and 8 illustrate a direction of a caster in accordance with the operation in FIGS. 5 and 6.

FIG. 9 is a front view of a step board according to a second exemplary embodiment of the present invention.

FIGS. 10 and 11 illustrate a travel direction of casters in accordance with the operation of the step board in FIG. 9.

FIG. 12 illustrates casters of a step board according to a third exemplary embodiment of the present invention.

### DESCRIPTION OF REFERENCE NUMERALS OF MAJOR PARTS OF DRAWINGS

100: step board 110: driving section
111: bars 113: hinge
115: footing 121: plate
123: roller 131: first caster
132: second casters 131w and 132w: wheels
140: base plate 141: rotating shaft
143: curved portion

### BEST MODE

Hereinafter, a step board according to exemplary embodiments of the present invention will be described with reference to accompanying drawings.

### First Exemplary Embodiment

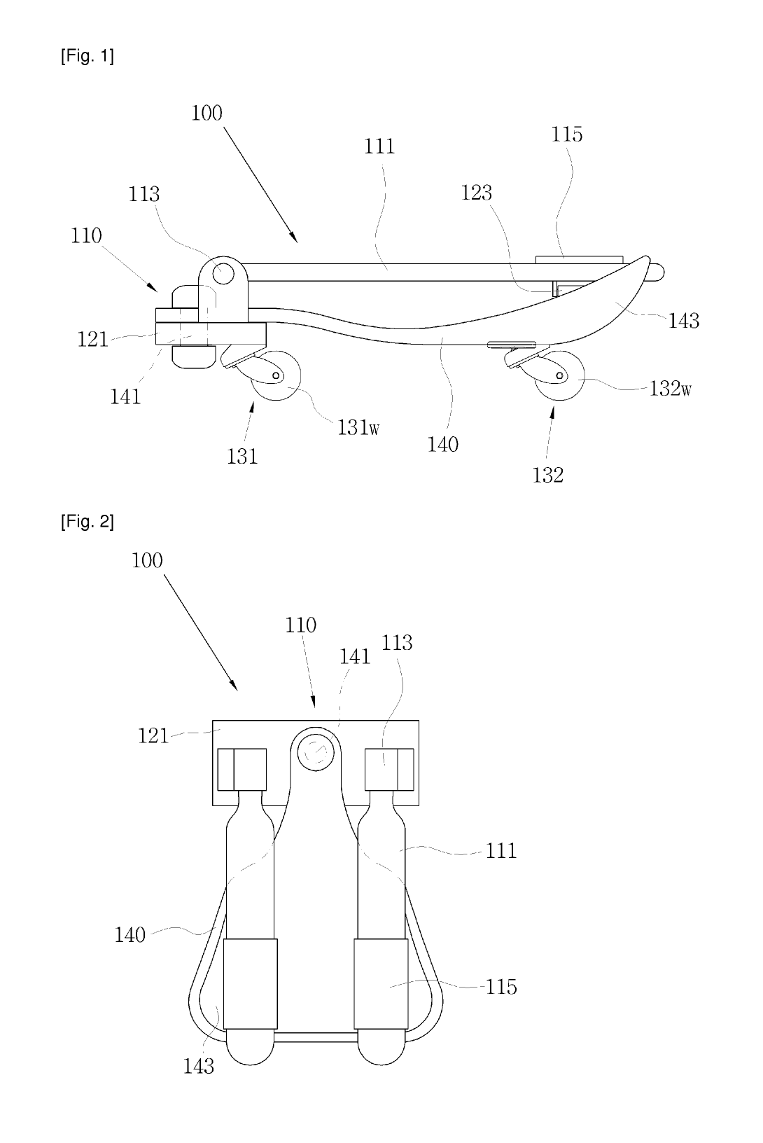

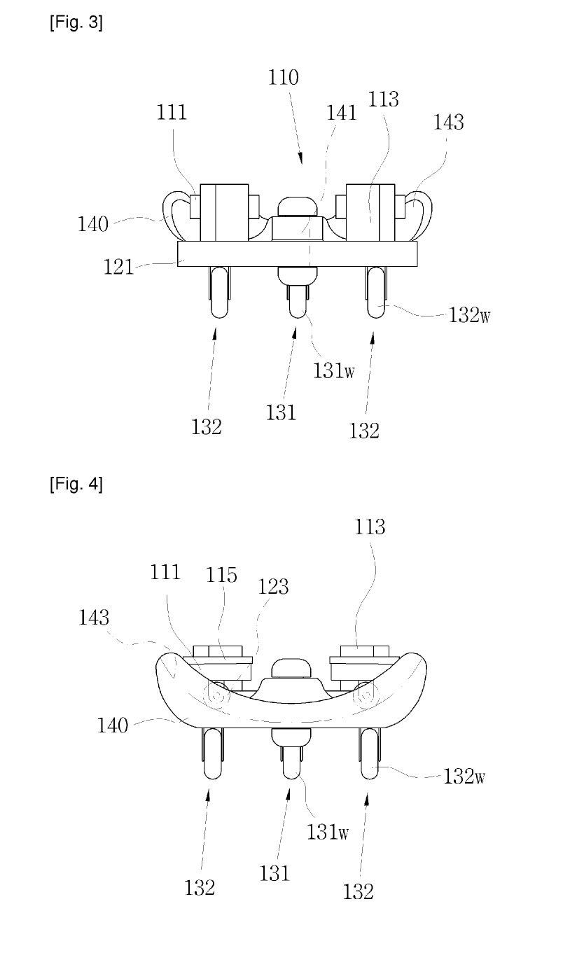

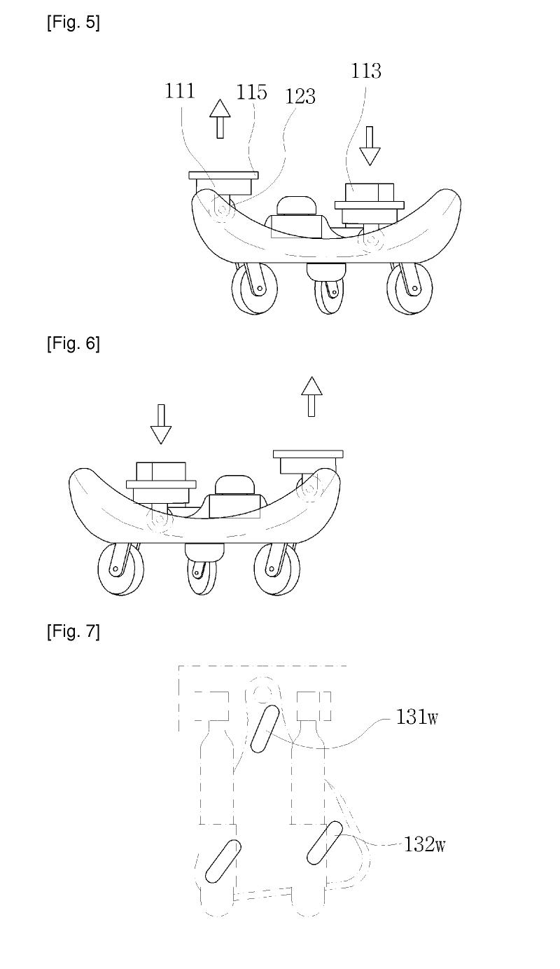

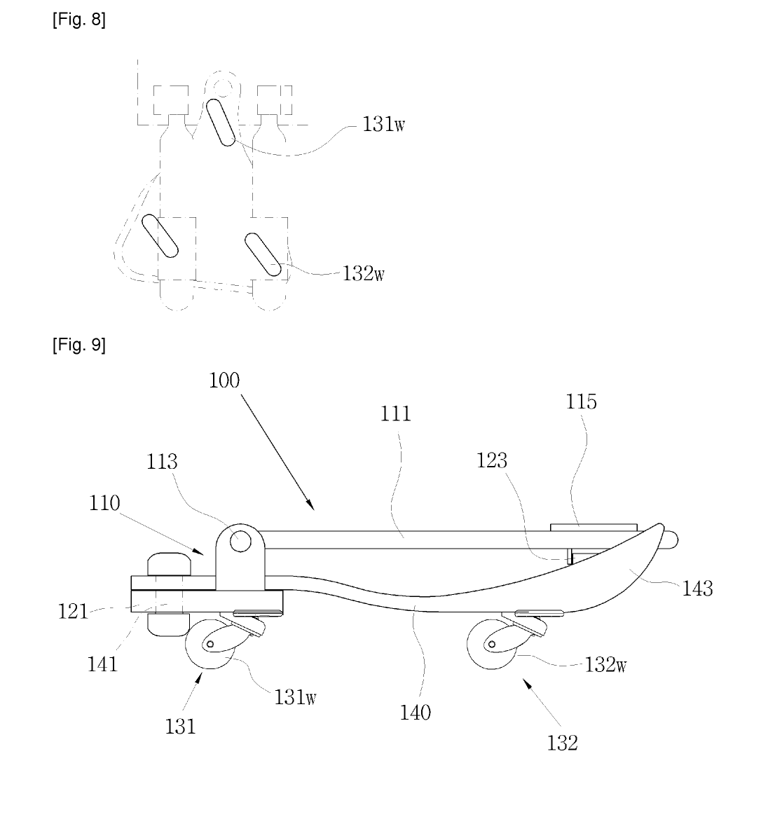

FIG. 1 is a front view of a step board according to a first exemplary embodiment of the present invention. FIG. 2 is a plan view of the step board in FIG. 1. FIG. 3 is a left side view of the step board in FIG. 1. FIG. 4 is a right side view of the step board in FIG. 1. FIGS. 5 and 6 are right side views of an operational relationship of the step board according to the present invention. FIGS. 7 and 8 illustrate a direction of a caster in accordance with the operation in FIGS. 5 and 6.

As shown in FIGS. 1 to 4, a step board 100 includes two bars 111 which are in parallel with each other, a driving section 110 which is coupled with the front ends of the bars 111 by a hinge 113 and rotatively supports the bars 111 in a vertical direction, a base plate 140 which is provided in a lower portion of the bars 111, has a front end disposed in an upper surface of the driving section 110 and is rotatively coupled with the driving section 110 in a horizontal direction on the basis of the bars 111, a first caster 131 which is mounted in a bottom surface of the front end of the driving section 110, and two second casters 132 which are shaped like a triangle together with the first caster 131 and mounted on a bottom surface of the base plate 140. As the bars 111 of the driving section 110 rotate in a vertical direction, the base plate 140 is pushed by the bars 111 and rotates in a horizontal direction and the three casters 131 and 132 generate a driving force.

With the foregoing configuration, the step board 100 will be described in more detail.

The driving section 110 includes a plate 121 which is provided in a front side, and two bars 111 which are parallel with each other and coupled to opposite sides of the plate 121 by hinge, respectively. The first caster 131 is mounted in a central portion of the bottom surface of the plate 121.

The two parallel bars 111 may have a footing 115 formed in the middle thereof. A user may step on the footing 115. The front ends of the two bars 111 are coupled to opposite sides of the plate 121 by the hinge 113. The bars 111 may rotate in a vertical direction on the basis of the plate 121. A roller 123 as a rotation body is mounted in the bottom surface of the bars 111, and an axial direction of the roller 123 is in parallel with a lengthwise direction of the bars 111. The roller 123 is located to contact the base plate 140 provided in a lower portion thereof.

The first caster 131 mounted in the bottom surface of the plate 121 and the second casters 132 mounted in the base plate 140 are directional casters, and are inclined to a rear side of a vertical line with respect to a location where the plate 121 is mounted. Wheels 131w and 132w of the casters 131 and 132 may rotate in a horizontal direction of the front side at the mounting location.

The driving section 110 having the foregoing configuration is mounted with the base plate 140.

The base plate 140 is a plate shaped like an isosceles triangle, and a front end of the base plate 140 is provided in a top surface of the plate 121 of the driving section 110. The front end of the base plate 140 and the plate 121 are coupled to a rotating shaft 141 so that the base plate 140 rotates centering on the rotating shaft 141 as if it draws a circle on a plane.

The two second casters 132 are mounted on the bottom surface of the base plate 140. The two second casters 132 are disposed in a triangular structure together with the first caster 131.

A curved portion 143 is formed on the base plate 140 which is shaped like an isosceles triangle. The curved portion 143 contacts the roller 123 of the bars 111 and is curved as if it is rolled upwards.

Hereinafter, an operational relationship of the step board 100 having the foregoing configuration will be described in more detail.

As shown in FIGS. 5 and 6, if a user steps on the base plate 115 and gives a more weight to one of his/her feet, one of the bars 111 goes down due to the weight, and the roller 123 mounted on the bar 111 going down rotates along a curved surface of the curved portion 143 of the base plate 140. Then, the base plate 140 rotates in an external direction of the foot given more weight. The rotation of the base plate 140 is possible because the plate 121 and the base plate 140 are rotatively coupled by the rotating shaft 141.

As the base plate 143 rotates in one side, the two second casters 132 and the first caster 131 become directional and generate a driving force. The principle of generating the driving force by the directional casters has been known already, and many products employing such principle (which are called “S Board” and “Step Board” which is the same as the title of the present invention) have been developed and used widely. Thus, the principle of generating the driving force by the directional casters will not be described herein.

In the step board 100 according to the present invention, as a user gives more weight to one of the bars 111, the base plate 140 rotates in an external direction of the foot having more weight to thereby generate the driving force.

If the weight is alternately given to two bars 111 of the step board 100, the base plate 140 rotates in a horizontal direction, the first and second casters 131 and 132 generate the driving force and the step board 100 travels in an S form s shown in FIGS. 7 and 8.

### Second Exemplary Embodiment

A step board according to a second exemplary embodiment of the present invention includes the same configuration as that according to the first exemplary embodiment except that the travel direction of the first and second casters is opposite to that in the first exemplary embodiment.

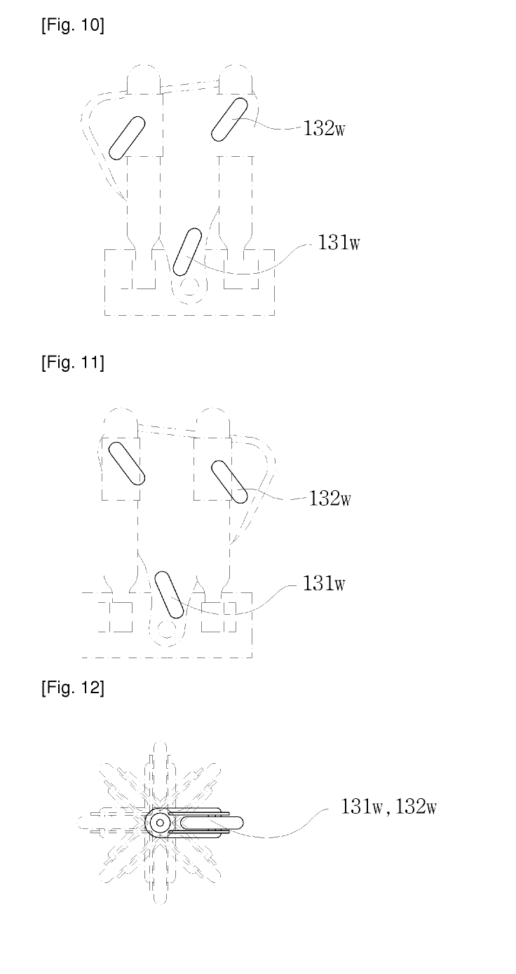

FIG. 9 is a front view of a step board according to a second exemplary embodiment of the present invention. FIGS. 10 and 11 illustrate a travel direction of the caster in accordance with the operation of the step board in FIG. 9.

As shown in FIG. 9, two second casters 132 are mounted in a bottom surface of a base plate 140. A first caster 131 is mounted in a bottom surface of a plate 121. Provided, the casters 131 and 132 are inclined to a front side of a vertical line with respect to a location where the plate 121 is mounted. Wheels 131w and 132w of the casters 131 and 132 may rotate in a horizontal direction in a rear side at a mounting location.

In the step board 100 according to the second exemplary embodiment, if a user steps on a footing 115 and alternately gives more weight to one of the bars 111, a rear end of the step board 100, in which the second caster 132 is provided, becomes a front end and travels. That is, in the base plate 140 shaped like a triangle, the portion having the two casters 132 becomes a front end, the plate 121 of the driving section 110 having the first caster 131 becomes a rear end and travels. The travel direction of the step board 100 according to the second exemplary embodiment is opposite to that according to the first exemplary embodiment, but the operation of the first and second casters 131 and 132 is the same as that in FIGS. 7 and 8.

### Third Exemplary Embodiment

The step board according to the first and second exemplary embodiments has the casters inclined to the rear side or front side centering on the mounting location thereof and rotate at a predetermined angle in a horizontal direction of the front side or the rear side in the mounting location. Accordingly, the step board according to the first and second exemplary embodiments has opposite travel directions.

FIG. 12 illustrates casters of a step board according to a third exemplary embodiment of the present invention.

As shown therein, first and second casters 131 and 132 are mounted to rotate 360 degrees centering on the mounting location thereof. Then, depending on the angle at which the first and second casters 131 and 132 are located, the step board 100 may travel forwards or backwards.

1. A step board which comprises a plurality of bars, each having a top surface to step thereon and a bottom surface mounted with a rotation body, a driving section hinge-coupled with the front ends of the bars for rotatively supporting the bars in the vertical direction and mounted with a first caster on the bottom surface thereof, and a base plate rotatively coupled with the driving section at the front end thereof, mounted with a plurality of second casters on the bottom surface thereof and curved at a portion corresponding to the rotation body, wherein the rotation body rolls to move by rotating along the curved portion of the base plate as the plurality of bars rotate in the vertical direction.

2. The step board according to claim 1, wherein the second casters comprise two casters and are provided in a triangular structure together with the first caster.

3. The step board according to claim wherein the first and second casters comprise directional casters which are inclined to one side at a mounting location.

4. The step board according to claim 3, wherein the first and second casters rotate 360 degrees at the mounting location.

5. The step board according to claim 1, wherein a footing is mounted in a top surface of the bars.

6. The step board according to claim 1, wherein a rotation body comprises a roller, which is mounted to have an axial direction that is in parallel with a lengthwise direction of the bars.

7. The step board according to claim 1, wherein the base plate is in a triangular structure, and a vertex in one side of the base plate is provided in a top surface of the driving section, wherein a rotating shaft passes through the base plate and the driving section, and the base plate rotates centering on the rotating shaft.

8. The step board according to claim 7, wherein the remaining two vertexes of the base plate are curved upwardly.

9. The step board according to claim 2, wherein the first and second casters comprise directional casters which are inclined to one side at a mounting location.

10. The step board according to claim 5, wherein a rotation body comprises a roller, which is mounted to have an axial direction that is in parallel with a lengthwise direction of the bars.
